(19) United States
(12) Patent Application Publication
(10) Pub. No.: US 2019/0366923 A1
(43) Pub. Date: Dec. 5, 2019

(54) VEHICLE REARVIEW MIRROR WITH BLIND SPOT INDICATOR FUNCTION

(71) Applicant: MAXZONE AUTO PARTS CORP., Fontana, CA (US)

(72) Inventor: Chao-Chun Chen, Changhua (TW)

(21) Appl. No.: 15/997,630

(22) Filed: Jun. 4, 2018

(51) Int. Cl. B60Q 9/00; B60R 1/12; B60R 1/06; F21S 43/30; F21S 43/14

(52) U.S. Cl. CPC B60Q 9/008; B60R 1/1207; F21S 43/14; F21S 43/30; B60R 1/06

(57) ABSTRACT

A vehicle rearview mirror with blind spot indicator function includes two blind spot indicators, a controller, a mirror mount, a mirror face defining a first light transmissive zone, and an indicator device including a reflector defining one or multiple reflecting surfaces and LED substrates and light-emitting devices mounted in the reflector. Each LED substrate defines a mounting face facing toward the reflecting surfaces. The light-emitting devices are mounted at the mounting faces of the LED substrates and kept beyond the first light transmissive zone, and controllable to emit light onto the reflecting surfaces so that the reflecting surfaces reflect the light through the first light transmissive zone toward the outside of the vehicle rearview mirror in a uniformly distributed manner. The light-emitting device is adapted to emit when the blind spot indicator detects at least one subject in a detecting area of the two blind spot indicators.

### TECHNICAL FIELD OF THE INVENTION

The present application generally relates to vehicle rearview mirrors, and more particularly, to a vehicle rearview mirror with blind spot indicator function.

### BACKGROUND OF THE INVENTION

A vehicle rearview mirror is used to compensate for the driver's blind spots, so that the driver can sec the road conditions around the vehicle through the rear view mirror. Some commercial vehicle rearview mirrors have an indicator device built therein for giving a visual directional indication signal, stop indication signal or rear car indication signal for enhancing road traffic safety.

Taiwan utility patent No. M301802 discloses a vehicle exterior rearview mirror, which includes a light-emitting device set between a lens and a mirror frame and controllable to emit light through the lens, giving a visual indication signal. However, subject to this light-emitting device mounting method, the light-emitting device is visible from the outside of the vehicle exterior rearview mirror even when the light-emitting device does no work. Further, the light emitted by the light-emitting device through the lens is not uniformly distributed. An improvement in this regard is necessary.

### SUMMARY OF THE INVENTION

The present application has been accomplished under the circumstances in view. It is the main object of the present application to provide a vehicle rearview mirror with blind spot indicator function, which is controllable to emit a uniform distribution of light, providing a visual indication.

To achieve this and other objects of the present application, a vehicle rearview mirror of a vehicle comprises two blind spot indicators, a controller, a mirror mount, a mirror, an indicator device and a light shield. The two blind spot indicators are disposed on a left side and a right side of the vehicle correspondingly, and are adapted to detect at least one subject in a detecting area. The controller is coupled to the two blind spot indicators. The mirror is mounted at the mirror mount. The mirror comprises a light transmissive substrate with a coating layer and has a first light transmissive zone formed in the light transmissive substrate and the coating layer. The indicator device is coupled to the controller and mounted between the mirror mount and the mirror. The indicator device comprises a reflector and at least one LED substrate mounted on an inner wall of the reflector. The reflector comprises at least one reflecting surface on the inner wall of the reflector. A bonding face faces toward the mirror. Each the LED substrate comprises a mounting face facing toward the at least one reflecting surface. At least one light-emitting device is mounted at the mounting face of each the LED substrate. The light shield comprises a second light transmissive zone partially overlapped on the first light transmissive zone, a first side connected to the bonding face, and a second side connected to the mirror. The at least one light-emitting device is oriented to emit peak luminance in a plane substantially parallel to the mirror and toward the at least one reflecting surface. The at least one reflecting surface is adapted to reflect the light emitted by the at least one light-emitting device through the first light transmissive zone toward the outside of the vehicle rearview mirror. The at least one fight-emitting device is adapted to emit when the blind spot indicator detects the at least one subject in the detecting area.

In various exemplary embodiments, the light shield further comprises a first adhesive layer arranged at the first side and bonded to the bonding face to secure the light shield to the reflector.

In various exemplary embodiments, the light shield further comprises a second adhesive layer arranged at the second side and bonded to the mirror to secure to the light shield to the mirror.

In various exemplary embodiments, the mirror mount defines therein an accommodation chamber. The indicator device is accommodated in the accommodation chamber of the mirror mount.

In various exemplary embodiments, the reflector further comprises a standing portion intersecting the mirror and facing the at least one reflecting surface, and the at least one LED substrate is mounted on the standing portion. The standing portion is mounted perpendicular to the mirror.

Another rearview mirror of a vehicle is also disclosed in the present application. The rearview mirror of the vehicle comprises two blind spot indicators, a controller, a mirror mount, a mirror, an indicator device and a light shield. The two blind spot indicators are disposed on a left side and a right side of the vehicle correspondingly, and are adapted to detect at least one subject in a detecting area. The controller is coupled to the two blind spot indicators. The mirror is made of a light transmissive substrate with a coating layer and mounted at the mirror mount. The mirror comprises a first light transmissive zone formed in the light transmissive substrate and the coating layer. The indicator device is coupled to the controller and mounted between the mirror mount and the mirror. The indicator device comprises a reflector and at least one LED substrate mounted in the reflector. The reflector comprises at least one reflecting surface. A bonding face faces toward the mirror. Each the LED substrate comprises a mounting face facing toward the at least one reflecting surface. At least one light-emitting device being mounted at the mounting face of each the LED substrate. The light shield comprises a second light transmissive zone partially overlapped on the first light transmissive zone, a first side connected to the bonding face, and a second side connected to the mirror. The at least one reflecting surface is adapted to reflect the light emitted by the at least one light-emitting device through the first light transmissive zone toward the outside of the vehicle rearview mirror. The at least one light-emitting device is adapted to emit when the blind spot indicator detects the at least one subject in the detecting area.

In various exemplary embodiments, the light shield further comprises a first adhesive layer arranged at the first side and bonded to the bonding face to secure the light shield to the reflector.

In various exemplary embodiments, the light shield further comprises a second adhesive layer arranged at the second side and bonded to the mirror to secure to the light shield to the mirror.

In various exemplary embodiments, the mirror mount defines therein an accommodation chamber; the indicator device is accommodated in the accommodation chamber of the mirror mount.

In various exemplary embodiments, the reflector further comprises a standing portion intersecting the mirror and facing the at least one reflecting surface, and the at least one LED substrate is mounted on the standing portion. The standing portion is mounted perpendicular to the mirror.

Because the indication light is reflected by the at least one reflecting surface before passing through the first light transmissive zone, the at least one light-emitting device needs not to emit light directly toward the first light transmissive zone. Therefore, the at least one light-emitting device can be mounted inside the vehicle rearview mirror and kept from sight and away from the first light transmissive zone. Because the light emitted by the at least one light-emitting device is reflected by the at least one reflecting surface, the light patter can be modified. Thus, the light passing through the first light transmissive zone has a uniform brightness, giving accurate visual indication when detecting the two blind spot indicators detect the at least one subject in the detecting area.

Numerous other advantages and features of the present application will become readily apparent from the following detailed description of disclosed embodiments, from the claims and from the accompanying drawings.

### BRIEF DESCRIPTION OF THE DRAWINGS

The objects, features and advantages of the present application will be more readily appreciated upon reference to the following disclosure when considered in conjunction with the accompanying drawings, wherein like reference numerals are used to identify identical components in the various views, and wherein reference numerals with alphabetic characters are utilized to identify additional types, instantiations or variations of a selected component embodiment in the various views, in which:

FIG. 1 is an operational view showing a vehicle rearview mirror with blind spot indicator function.

FIG. 2 is a block diagram of the vehicle rearview mirror with blind spot indicator function of a vehicle.

FIG. 3 is an elevational view of the vehicle rearview mirror with blind spot indicator function in accordance with a first embodiment of the present application.

FIG. 4 is an exploded view of the vehicle rearview mirror with blind spot indicator function in accordance with the first embodiment of the present application.

FIG. 5 is a sectional view of the vehicle rearview mirror with blind spot indicator function in accordance with the first embodiment of the present application.

FIG. 6 is a schematic sectional view of a part of the first embodiment of the present application, illustrating the first light transmissive zone of the mirror face.

FIG. 7 is a schematic sectional view of a part of a vehicle rearview mirror with blind spot indicator function in accordance with a second embodiment of the present application, illustrating a first light transmissive zone in a mirror face.

FIG. 8 is an exploded view of a vehicle rearview mirror with blind spot indicator function in accordance with a third embodiment of the present application (the mirror face is not shown).

FIG. 9 is a sectional view of the vehicle rearview mirror with blind spot indicator function in accordance with the third embodiment of the present application.

FIG. 10 is a schematic sectional view of a part of the third embodiment of the present application, illustrating the arrangement of the mirror face, the light shield and the reflector.

### DETAILED DESCRIPTION OP DISCLOSED EMBODIMENTS

Reference will now be made in detail to the present representative embodiments of the present application, examples of which are illustrated in the accompanying drawings. Wherever possible, the same reference numbers are used in the drawings and the description to refer to the same or like parts.

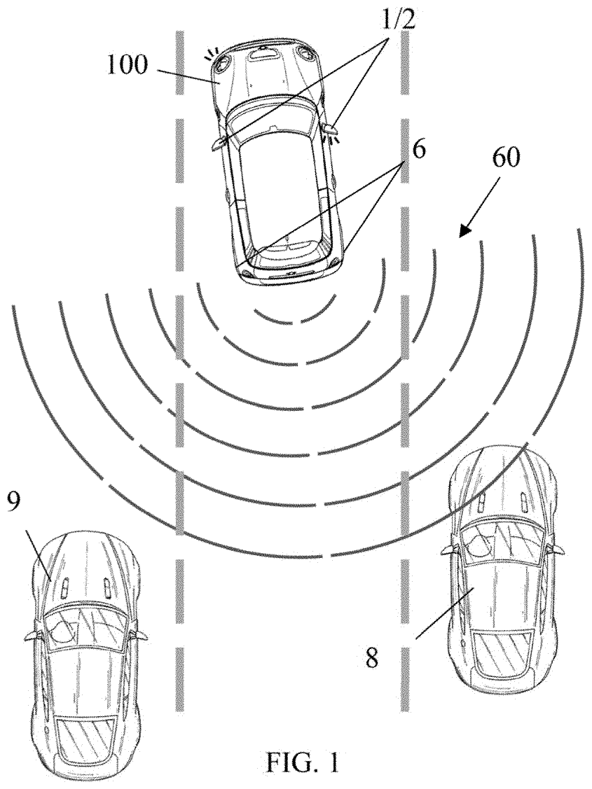

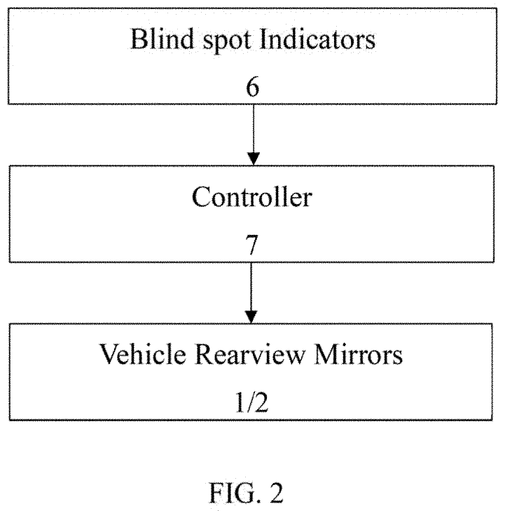

FIG. 1 is an operational view showing a vehicle rearview mirror with blind spot indicator function. FIG. 2 is a block diagram of the vehicle rearview mirror with blind spot indicator function of a vehicle.

Referring to FIGS. 1-2, a vehicle 100 comprises two vehicle rearview mirrors 1/2, two blind spot indicators 6 and a controller 7. Two blind spot indicators 6 are disposed on a left side and a right side of the vehicle 100 correspondingly and are adapted to detect at least one subject in a detecting area 60.

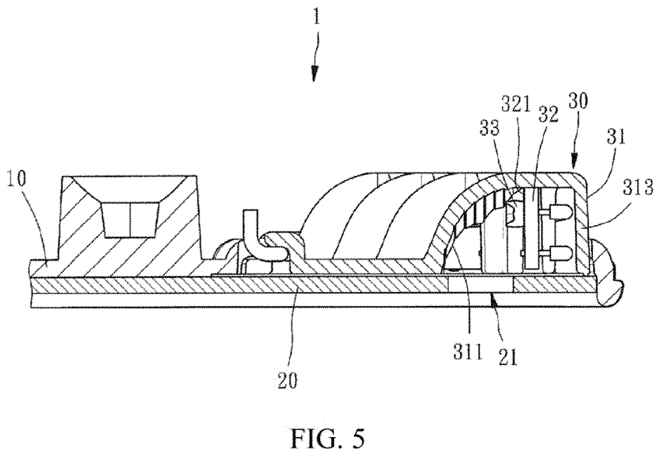

The controller 7 is coupled to the two blind spot indicators 6 and the vehicle rearview mirrors 1/2. Specifically, the controller 7 is capable of controlling a light-emitting device 33 (referring to FIG. 5) of an indicator device 30 of the vehicle rear view mirrors 1/2 to emit when the blind spot indicator 6 detects the at least one subject in the detecting area 60.

For example, as shown in FIG. 1, a vehicle 8 is in the detecting area 60 but a vehicle 9 is not. When the vehicle 8 is detected by the blind spot indicators 6 of the vehicle 100, the light-emitting device 33 of the vehicle rearview mirrors 1/2 at the corresponding side will emit to alert the driver of the vehicle 100. However, the present application is not limited in the subject as a vehicle, the subject may also be a human, a tree, traffic cones or a traffic light, the present application is not limited thereto.

Therefore, the drive of the vehicle 100 may have the notification of whether there is a subject in detecting area 60. For instance, as shown in FIG. 1, it is safe for the driver of the vehicle 100 to turn left since there is no subject in a left portion of the detecting area 60. However, since vehicle 8 is in a right portion of the detecting area 60, it is dangerous for the driver of the vehicle 100 to turn right until the vehicle 8 passes through the vehicle 100.

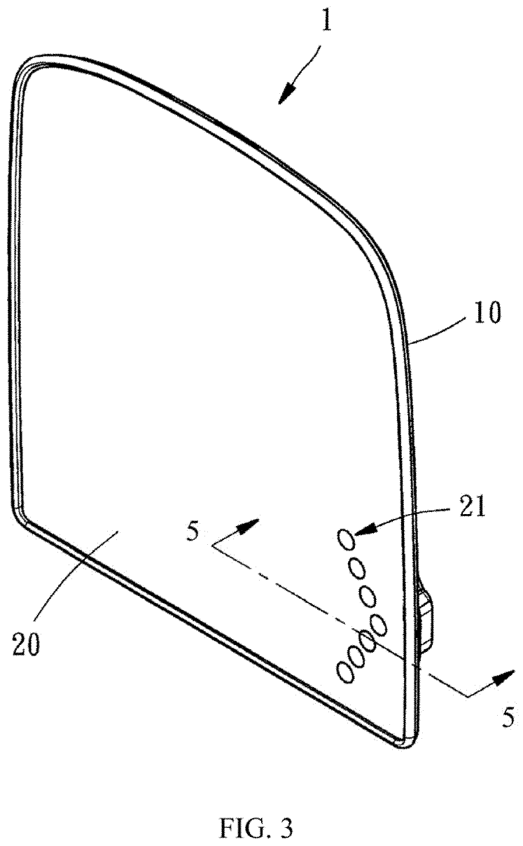

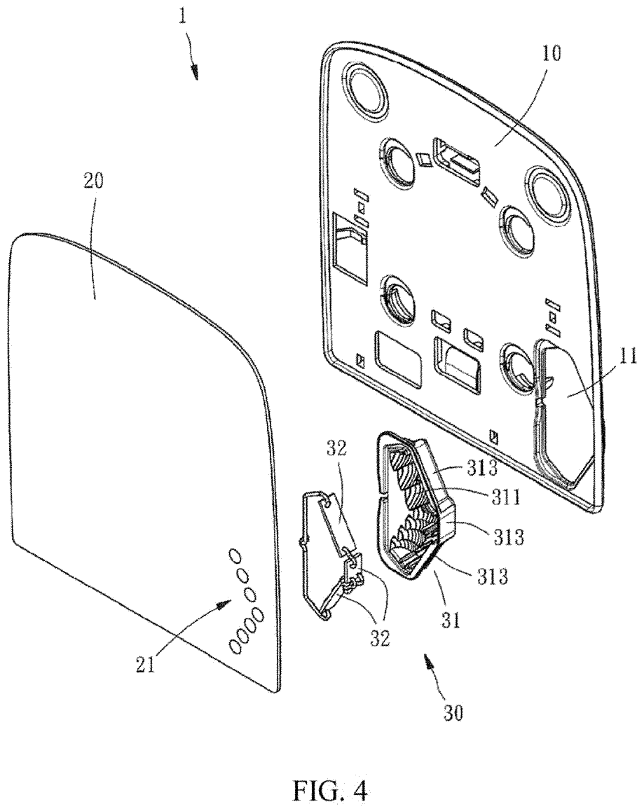

FIG. 3 is an elevational view of the vehicle rearview mirror with blind spot indicator function in accordance with a first embodiment of the present application. FIG. 4 is an exploded view of the vehicle rearview mirror with blind spot indicator function in accordance with the first embodiment of the present application. FIG. 5 is a sectional view of the vehicle rearview mirror with blind spot indicator function in accordance with the first embodiment of the present application.

Referring to FIGS. 3-5, a vehicle rearview mirror 1 with blind spot indicator function in accordance with a first embodiment of the present application is shown. The vehicle rearview mirror 1 comprises a mirror mount 10, a mirror face 20, and an indicator device 30. The vehicle rearview mirror 1 can be mounted in a casing (not shown), and then installed in the outside of a motor vehicle by means of the casing.

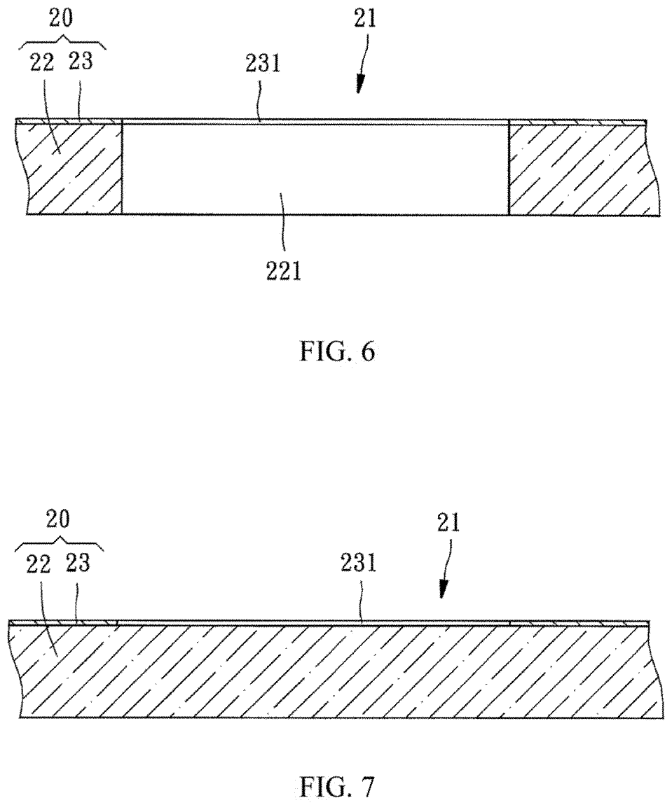

FIG. 6 is a schematic sectional view of a part of the first embodiment of the present application, illustrating the first light transmissive zone of the mirror face.

The mirror face 20 is mounted in the mirror mount 10, comprising a first light transmissive zone 21. The first light transmissive zone 21 can be configured subject to the signals to be indicated. As illustrated in FIG. 6, the mirror face 20 is made of a light transmissive substrate 22 selected from, for example, glass or acrylic, and having the back (inner) side thereof covered with a coating layer 23. The first light transmissive zone 21 is formed of a plurality of apertures 221,231 that are respectively formed in the light transmissive substrate 22 and the coating layer 23.

The indicator device 30 is mounted between the mirror mount 10 and the mirror face 20, more specifically, the indicator device 30 is mounted in an accommodation chamber 11 in the mirror mount 10. Further, the indicator device 30 comprises a reflector 31, and at least one LED substrate 32 and at least one light-emitting device, for example, LED 33. The number of the at least one LED substrate 32 and the number of the at least one LED 33 are not limited For example, the number of the at least one LED substrates 32 can be 3, and a plurality of LEDs 33 can be installed in the LED substrate 32.

The reflector 31 defines therein at least one reflecting surface 311. Mach reflecting surface 311 corresponds to at least one light-emitting device 33. The LED substrates 32 are mounted in the reflector 31 opposite to the reflecting surfaces 311, each having a mounting face 321 facing toward at least one reflecting surface 311. The LEDs 33 are respectively mounted at the mounting faces 321 of the LED substrates 32 and adapted to emit light toward the reflecting surfaces 311 so that the reflecting surfaces 311 can reflect the light emitted by the LEDs 33 through the first light transmissive zone 21 to the outside of the mirror face 20, giving a visual indication signal to other drivers or passers-by. Also, in some embodiments the reflector 31 further defines a standing portion 313 perpendicular to the mirror face 20 and facing the at least one reflecting surface 311, and the at least one LED substrate 32 is mounted on the standing portion 313.

In this first embodiment, the light emitted by the LEDs 33 is reflected by the reflecting surfaces 311 toward the first light transmissive zone 21. Thus, the reflecting surfaces 311 can be properly configured to reflect light, providing a uniform light field. Further, it is not necessary to keep the light-emitting device 33 aiming at the mirror face 20 accurately. For example, the mounting faces 321 of the LED substrates 32 can be mounted perpendicular to the mirror face 20, keeping the axes of light of the light-emitting devices 33 in parallel to the mirror face 20, minimizing the exposed area of the LEDs 33 beyond the first light transmissive zone 21 and reducing the possibility that a person can see the LEDs 33 from the outside through the mirror face 20.

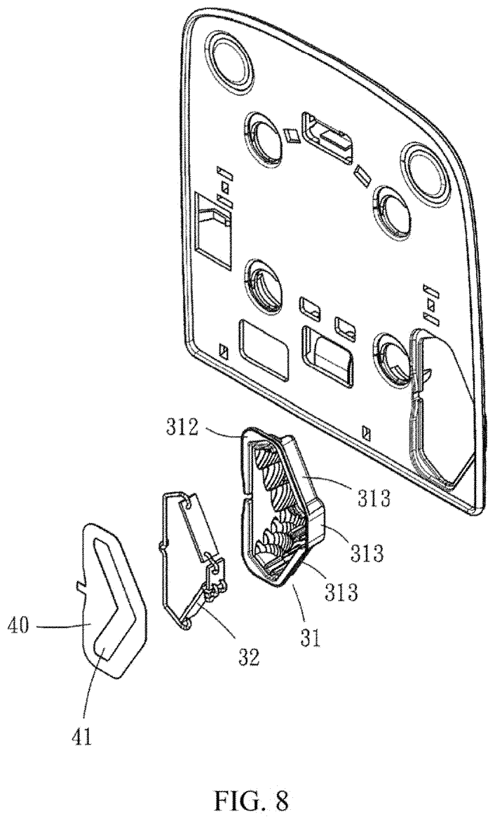

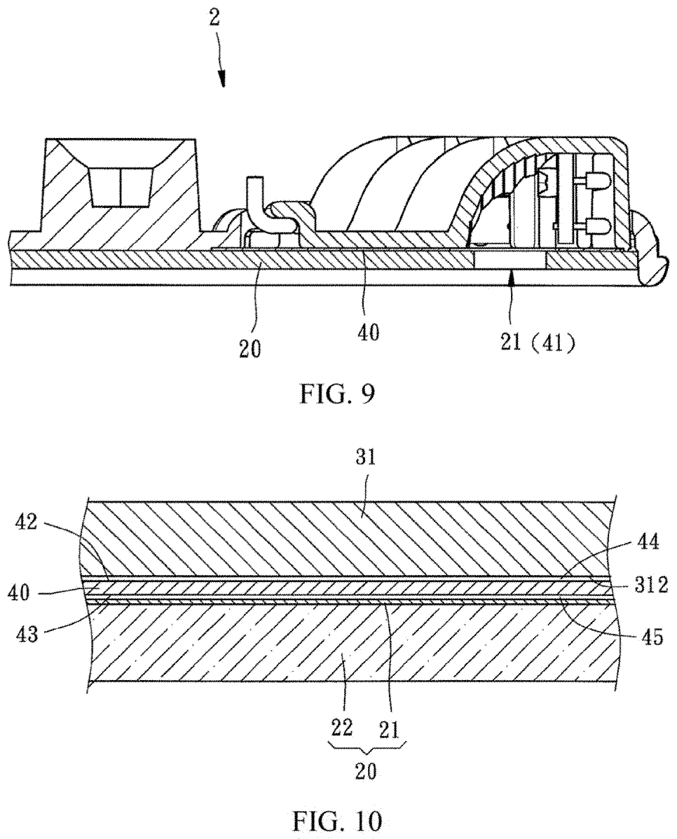

FIG. 7 is a schematic sectional view of a part of a vehicle rearview mirror with blind spot indicator function in accordance with a second embodiment of the present application, illustrating a first light transmissive zone in a mirror face. FIG. 8 is an exploded view of a vehicle rearview mirror with blind spot indicator function in accordance with a third embodiment of the present application (the mirror face is not shown). FIG. 9 is a sectional view of the vehicle rearview mirror with blind spot indicator function in accordance with the third embodiment of the present application.

In a second embodiment of the present application, the structure of the mirror face 20 is modified, i.e., the coating layer 23 of the mirror face 20 defines at least one aperture 231, as shown in FIG. 7, through which the light emitted by the LEDs 33 can go from the inside of the mirror face 20 toward the outside.

On the other hand, different users may have different preferences for the appearance of the indication signal. If you directly change the shape of the first light transmissive zone 21 of the mirror face 20, the work may be difficult to achieve, or the cost may be excessively high. FIGS. 8 and 9 illustrate a vehicle rearview mirror with blind spot indicator function in accordance with a third embodiment of the present application. According to this third embodiment, the vehicle rearview mirror 2 further comprises a light shield 40 made from plastics or other suitable material. The light shield 40 is mounted on a bonding face 312 of the reflector 31 that faces toward the mirror face 20. The light shield 40 is opaque to light but processed to provide an opening forming a second light transmissive zone 41. The second light transmissive zone 41 has at least a pan thereof overlapped on the first light transmissive zone 21. The overlapped area between the second light transmissive zone 41 and the first light transmissive zone 21 defines the shape of the indication signal. Because the installation cost of the light shield 40 is much lower than the mirror face 20, the light shield 40 can easily be processed to provide the second light transmissive zone 41. Therefore, this embodiment can lower the cost of custom design.

It's worth mentioning that the light shield can be designed in an alternate form, comprising a substrate and at least one cover layer, wherein the substrate is made from a transparent or translucent material, for example, plastics or acrylic, having at least one of two opposite sides thereof partially covered with a cover layer so that the other area beyond the cover layer defines the second light transmissive zone.

FIG. 10 is a schematic sectional view of a part of the third embodiment of the present application, illustrating the arrangement of the mirror face, the light shield and the reflector.

As shown in FIG. 10, to facilitate installation of the light shield 40, a first adhesive layer 44 and a second adhesive layer 45 are respectively arranged on opposing first side 42 and second side 43 of the light shield 40, enabling the first side 42 and second side 43 of the light shield 40 to be respectively bonded to the bonding face 312 of the reflector 31 and the mirror face 20 by the first adhesive layer 44 and the second adhesive layer 45. The first adhesive layer 44 and the second adhesive layer 45 are preferably selected from a reusable adhesive material. Further, the first adhesive layer 44 and the second adhesive layer 45 both or one of them can be omitted. Further, the distribution of the first adhesive layer 44 and the second adhesive layer 45 does not overlap with the first light transmissive zone 21 so that any person cannot see the first adhesive layer 44 and the second adhesive layer 45 from the outside of the vehicle rearview mirror, increasing the aesthetic value.

Because the indication light is reflected by the at least one reflecting surface before passing through the first light transmissive zone, the at least one light-emitting device needs not to emit light directly toward the first light transmissive zone. Therefore, the at least one light-emitting device can be mounted inside the vehicle rearview mirror and kept from sight and away from the first light transmissive zone. Because the light emitted by the at least one light-emitting device is reflected by the at least one reflecting surface, the light patter can be modified. Thus, the light passing through the first light transmissive zone has a uniform brightness, giving accurate visual indication when detecting the two blind spot indicators detect the at least one subject in the detecting area.

Although a particular embodiment of the invention has been described in detail for purposes of illustration, various modifications and enhancements may be made without departing from the spirit and scope of the invention. Accordingly, the invention is not to be limited except as by the appended claims.

It will be apparent to those skilled in the art that various modifications and variations can be made to the structure of the present application without departing from the scope or spirit of the present application. In view of the foregoing, it is intended that the present application cover modifications and variations of this application provided they fall within the scope of the following claims and their equivalents.

1. A vehicle with rearview mirrors, comprising:
two blind spot indicators disposed one left side and a tight side of the vehicle correspondingly, the two blind spot indicators are adapted to detect at least one subject in a detecting area;
a controller coupled to the two blind spot indicators;
a pair of mirror mount;
a pair of mirror mounted at the pair of mirror mount, each of the mirror comprising a light transmissive substrate with a coating layer and having a first light transmissive zone formed in the light transmissive substrate with the coating layer;
a pair of indicator device coupled to the controller, wherein each of the indicator is mounted between one of the mirror mount and the corresponding mirror, each of the indicator device comprises a reflector and at least one LED substrate mounted on an inner wall of the reflector, the reflector comprising at least one reflecting surface on the inner wall of the reflector, and a bonding face facing toward the mirror, the at least one LED substrate comprising a mounting face facing toward the at least one reflecting surface, at least one light-emitting device being mounted at the mounting face of the at least one each the LED substrate; and
a pair of light shield, each of the light shield comprises a second light transmissive zone partially overlapped on the first light transmissive zone, a first side connected to the bonding face, and a second side connected to the mirror,
wherein the at least one light-emitting device is oriented to emit peak luminance in a plane substantially parallel to the mirror and toward the at least one reflecting surface,
wherein the at least one reflecting surface is adapted to reflect the light emitted by the at least one light-emitting device through the first light transmissive zone toward the outside of the vehicle rearview mirror,
wherein the at least one light-emitting device is adapted to emit when the two blind spot indicators detect the at least one subject in the detecting area.

2. The vehicle with rearview mirrors as claimed in claim 1, wherein each of the light shield farther comprises a first adhesive layer arranged at the first side and bonded to the bonding face to secure the light shield to the reflector.

3. The vehicle with rearview mirrors as claimed in claim 1, wherein each of the light shield further comprises a second adhesive layer arranged at the second side and bonded to the mirror to secure to the light shield to the mirror.

4. The vehicle with rearview mirrors as claimed in claim 1, wherein each of the mirror mount defines therein an accommodation chamber; the indicator device is accommodated in the accommodation chamber of the mirror mount.

5. The vehicle with rearview mirrors as claimed in claim 1, wherein the reflector further comprises a standing portion intersecting the mirror and facing the at least one reflecting surface, and the at least one LED substrate is mounted on the standing portion.

6. The vehicle with rearview mirrors as claimed in claim 5, wherein the standing portion is mounted perpendicular to the mirror.

7. A vehicle with rearview mirrors, comprising:
two blind spot indicators disposed on a left side and a right side of the vehicle correspondingly, the two blind spot indicators are adapted to detect at least one subject in a detecting area;
a controller coupled to the two blind spot indicators;
a pair of mirror mount;
a pair of mirror made of a light transmissive substrate with coating layer and mounted at the pair of mirror mount, each of the mirror comprising a first light transmissive zone formed in the light transmissive substrate with the coating layer;
a pair of indicator device coupled to the controller, wherein each of the indicator is mounted between one of the mirror mount and the corresponding mirror, each of the indicator device comprises a reflector and at least one LED substrate mounted in the reflector, the reflector comprising at least one reflecting surface, and a bonding face facing toward the mirror, the at least one LED substrate comprising a mounting face facing toward the at least one reflecting surface, at least one light-emitting device being mounted at the mounting face of the at least one LED substrate; and
a pair of light shield, each of the light shield comprises a second light transmissive zone partially overlapped on the first light transmissive zone a first side connected to the bonding face, and a second side connected to the mirror,
wherein the at least one reflecting surface is adapted to reflect the light emitted by the at least one light-emitting device through the first light transmissive zone toward the outside of the vehicle rearview mirror,
wherein the at least one light-emitting device is adapted to emit when the two blind spot indicators detect the at least one subject in the detecting area.

8. The vehicle with rearview mirrors as claimed in claim 7, wherein each of the light shield further comprises a first adhesive layer arranged at the first side and bonded to the bonding face to secure, the light shield to the reflector.

9. The vehicle with rearview mirrors as claimed in claim 7, wherein each of the light shield further comprises a second adhesive layer arranged at the second side and bonded to the mirror to secure to the light shield to the mirror.

10. The vehicle with rearview mirrors as claimed in claim 7, wherein each of the mirror mount defines therein an accommodation chamber; the indicator device is accommodated in the accommodation chamber of the mirror mount.

11. The vehicle with rearview mirrors as claimed in claim 7, wherein the reflector further comprises a standing portion intersecting the mirror and facing the at least one reflecting surface, and the at least one LED substrate is mounted on the standing portion.

12. The vehicle with rearview mirrors as claimed in claim 11, wherein the standing portion is mounted perpendicular to the mirror.
